(19) United States
(12) Patent Application Publication
(10) Pub. No.: US 2017/0051697 A1
(43) Pub. Date: Feb. 23, 2017

(54) METHOD AND SYSTEM FOR VEHICLE ROLLOVER ENGINE PROTECTION, EMERGENCY CALL AND LOCATION SERVICES

(71) Applicant: Robert Bosch GmbH, Stuttgart (DE)

(72) Inventor: Bryan CAMPBELL, White Lake, MI (US)

(73) Assignee: Robert Bosch GmbH, Stuttgart (DE)

(21) Appl. No.: 15/307,416

(22) PCT Filed: May 15, 2015
(86) PCT No.: PCT/US2015/030971

§ 371 Date: Oct. 28, 2016

Related U.S. Application Data
(60) Provisional application No. 61/993,688, filed on May 15, 2014.

(51) Int. Cl. F02D 41/22; H04W 4/22; F02D 41/26; F02D 41/30; B60R 21/013; G01S 19/42

(52) U.S. Cl. CPC F02D 41/22; B60R 21/013; G01S 19/42; F02D 41/26; F02D 41/3005; H04W 4/22; B60R 2021/0018

(57) ABSTRACT

A vehicle rollover engine protection and location system 10 for an off-road vehicle includes an inertial sensor unit 22, a communication bus 18 for providing communication from both the rollover sensor 22 and a global positioning system 40 to an electronic control unit 12. When a vehicle rollover has occurred, a processor 14 of the electronic control unit 12 is configured to stop providing fuel to an engine of the off-road vehicle, stop operation of the fuel pump, determine a location of the off-road vehicle from signals of the global positioning system, perform a rollover emergency call to actively indicate rollover of the off-road vehicle, and transmit a location signal.

### RELATED APPLICATIONS

This application claims priority from U.S. provisional application 61/993,688, filed May 15, 2014, the entire content of which is hereby incorporated by reference.

### BACKGROUND

The invention is directed to enhancements for three and four wheeled vehicles, including an electronic stability program (ESP) electronic control unit (ECU), a performance hand brake, a driver configurable yaw control, a stability mode switch, and an arrangement for providing roll-over protection.

Four wheeled off-road vehicles, such as side-by-side vehicles (S×Ss), recreational off highway vehicles (ROVs), utility terrain vehicles (UTVs) and all-terrain vehicles (ATVs), are known for driving on rugged terrain. Other four wheeled vehicles include dune buggies, rally cars and other on-road or off-road vehicles that are driven for racing or fun. Rally cars often use a hydraulic hand brake to supply the rear calipers with brake pressure to initiate vehicle oversteer. Three wheeled vehicles include both on-road and off-road applications.

When an UTV or an ATV is subject to rollover, the vehicle engine continues to operate. The oil pan, however, no longer necessarily contains oil due to the change in orientation of the vehicle. Thus, engine damage occurs when the engine operates in a position where gravity does not return oil to the oil pan. Therefore, an object is to prevent engine operation in the event of rollover of an off-road vehicle, in addition to avoiding the obvious risks from leaking combustible fluid onto or near the vehicle.

The hand brake of a vehicle has long been a tool used by drivers in high performance driving in order to change the trajectory of the vehicle. On tight racetracks, rally stages, or other specialized situations the driver uses the hand brake to reach a higher yaw rate than normally possible and quickly change vehicle trajectory. Traditional hand brake actuation is through a mechanical linkage comprised of either a system of cables or a separate hydraulic circuit.

### SUMMARY

The invention is directed to enhancements for vehicles One embodiment is a vehicle rollover engine protection system for a vehicle including an engine, comprising: an inertial sensor unit for sensing rollover of the vehicle; a fuel injection control; a fuel pump control; an electronic control unit including a processor and a memory; and a communication bus for providing communication from the inertial sensor unit to the electronic control unit, and for providing communication between the electronic control unit and each of the fuel injection control and the fuel pump control. When the electronic control unit receives an inertial sensor unit signal indicating that a vehicle rollover has occurred, the processor of the electronic control unit is configured to: close fuel injectors to cut-off fuel to the engine of the vehicle with the fuel injection control, and stop operation of a fuel pump of the engine with the fuel pump control.

In one embodiment, the vehicle is from a group consisting of all-terrain vehicles, recreational off highway vehicles, side-by-side vehicles, utility terrain vehicles, dune buggies and rally cars.

In one embodiment, the inertial sensor unit senses force about at least a z-axis.

In another embodiment, a method of protecting an engine in a vehicle rollover event for an off-road vehicle comprises: sensing rollover of the off-road vehicle and providing an inertial sensor unit signal; closing fuel injectors to cut-off fuel to the engine of the off-road with a fuel injection control in response to the sensing rollover of the off-road vehicle; and stopping operation of a fuel pump for the engine of the off-road vehicle in response to the sensing rollover of the off-road vehicle.

In one embodiment, a vehicle rollover engine protection and location system for a vehicle including an engine comprises an inertial sensor unit for sensing rollover of the vehicle, a fuel injection control, a fuel pump control, a global positioning system, a rollover emergency caller, a location signal transmitter, an electronic control unit including a processor and a memory, and a communication bus for providing communication from the inertial sensor unit and the global positioning system to the electronic control unit, and for providing communication between the electronic control unit and each of the fuel injection control, the fuel pump control, the location signal transmitter and the rollover emergency caller. When the electronic control unit receives an inertial sensor unit signal indicating that a vehicle rollover has occurred, the processor of the electronic control unit is configured to: close fuel injectors to cut-off fuel to the engine of the vehicle, stop operation of a fuel pump of the engine with the fuel pump control, determine a location of the vehicle from signals from the global positioning system, perform a rollover emergency call to actively indicate rollover of the vehicle and to provide vehicle identification and location, and transmit a location signal.

In one embodiment, the location signal of the location signal transmitter includes a distress beacon.

Other aspects of the invention will become apparent by consideration of the detailed description and accompanying drawings.

### BRIEF DESCRIPTION OF THE DRAWINGS

FIG. 1 is a block diagram for an embodiment of a vehicle control system.

FIG. 2 is a perspective view of an inertial sensor unit for detecting stability of a vehicle.

FIG. 3 is a flow chart showing operation of a vehicle rollover engine protection and location system.

FIG. 4 is a side view of a hand brake.

FIG. 5 is view of a display on a user interface.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

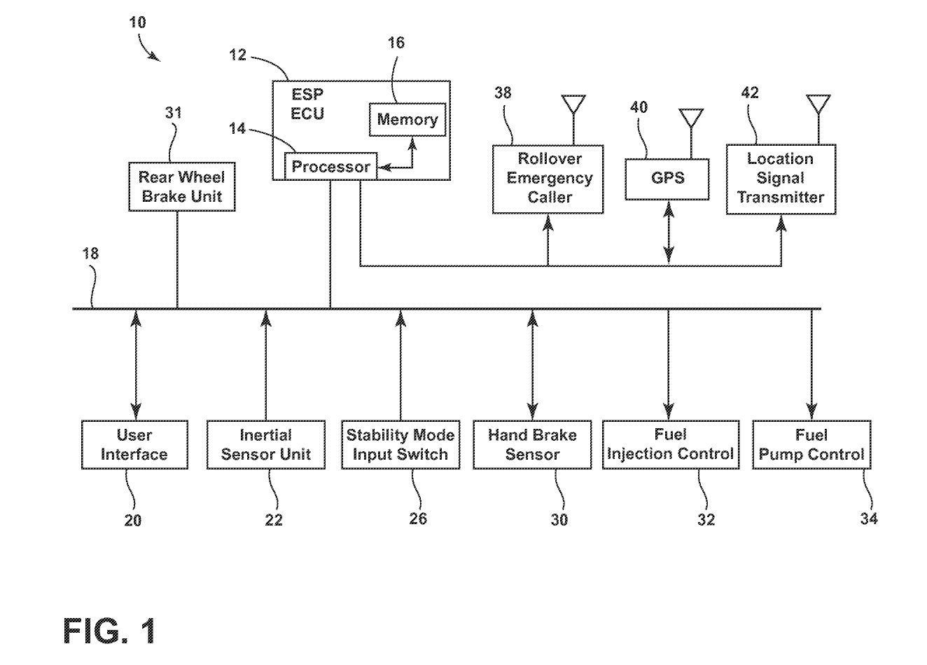

FIG. 1 shows a multi-purpose vehicle control system 10 for a vehicle that acts as a stability control system and as an off-road vehicle rollover engine protection system. The vehicle control system 10 includes an electronic control unit, and more specifically in some embodiments an electronic stability program (ESP) electronic control unit (ECU) 12. The ECU 12 includes a processor 14 and a memory 16. In one embodiment, the memory 16 stores programs and algorithms that are executable by the processor 14. A communication bus, in one embodiment a controller area network (CAN) bus 18, provides communication between the ECU 12 and other devices discussed below. Other communication buses, including a FlexRay bus and an Ethernet, are contemplated.

FIG. 1 also shows a user interface 20 for a user to provide inputs or outputs to the vehicle control system 10. The user interface 20 provides visual and/or audio information to a user. In one embodiment, the user interface 20 is a graphical user interface provided as a touch screen for a user to select menus and other items. The user interface 20 communicates with the ECU 12 via the CAN bus 18.

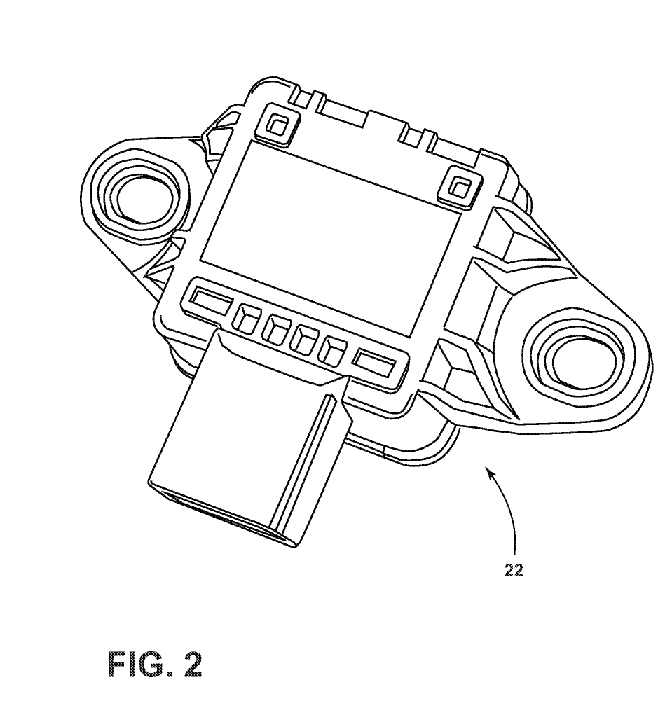

Inertial sensor unit 22 in FIG. 1 senses various forces including yaw, roll and force about a x-axis, a y-axis, and a z-axis, including determining rollover of a vehicle based on at least the force about the z-axis. The inertial sensor unit 22 communicates with the ECU 12 via the CAN bus 18. FIG. 2 shows one embodiment of an inertial sensor unit 22. In one embodiment, the inertial sensor unit 22 acts as a rollover sensor outputting a rollover sensor signal indicating rollover of the vehicle. In other embodiments, a rollover sensor is provided as a switch device, or other type of sensor. In one embodiment, rollover of a vehicle is sensed by force about the z-axis of the inertial sensor unit 22. In some embodiments, additional sensors to confirm rollover are contemplated.

Stability mode input switch 26 in FIG. 1 is a tactile selection switch for selecting an operating mode. In some embodiments, the user interface 20 performs the stability mode selection. The stability mode input switch 26 communicates with the ECU 12 via the CAN bus 18.

Hand brake sensor 30 shown in FIG. 1 is provided as a sensor on an electronic hand brake. The hand brake sensor 30 senses force applied to the hand brake and provides a force signal to the ECU 12 via the CAN bus 18, and in one embodiment an electrical force signal.

Rear wheel brake unit 31 shown in FIG. 1 is provided to apply brake pressure to rear wheels of the vehicle in response to use of an electronic hand brake. Rear wheel braking may cause oversteer as described later herein.

The vehicle control system 10 includes a fuel injection control 32. In one embodiment, the fuel injection control 32 closes fuel injectors to block fuel from the combustion chambers of a vehicle engine. The fuel injection control 32 receives a fuel cut-off signal from the ECU 12 via the CAN bus 18. In response to an input signal or command, the fuel injection control 32 operates to close fuel injectors.

The vehicle control system 10 of FIG. 1 further includes a fuel pump control 34. In one embodiment, the fuel pump control 34 is part of a powertrain of a vehicle that provides cut-off of power to a fuel pump for a vehicle engine. In operation, the ECU 12 sends a fuel pump stop signal to the fuel pump control 34 via the CAN bus 18. Thus, fuel pump power is disconnected.

FIG. 1 also shows a rollover emergency caller 38 for calling authorities or other preselected parties in response to rollover of a vehicle that includes the vehicle control system 10. The rollover emergency caller 38 is preprogrammed with police, fire, ambulance and other telephone numbers. When an emergency condition has occurred, the ECU 12 provides an output so that an emergency number for the rollover emergency caller 38 via the CAN bus 18.

FIG. 1 shows a global positioning system (GPS) 40 for a vehicle to obtain positioning information for a vehicle provided with the GPS 40. GPS 40 is a receiver that receives signals from satellites. The CAN bus 18 provides GPS signals from the GPS 40 to the ECU 12. GLONASS and GALILEO are additional global positioning systems 40 contemplated for use in the vehicle control system 10.

The vehicle control system 10 includes a location signal transmitter 42. The location signal transmitter 42 essentially continuously transmits a location or homing signal, such as a beacon. The location signal allows a searcher to directly track and locate the vehicle that the location signal transmitter 42 is secured upon.

While the rollover emergency caller 38, the GPS 40 and the location signal transmitter 42 each are illustrated in FIG. 1 as having an individual antenna, in some embodiments antennas are shared by multiple devices.

### Rollover Engine Protection

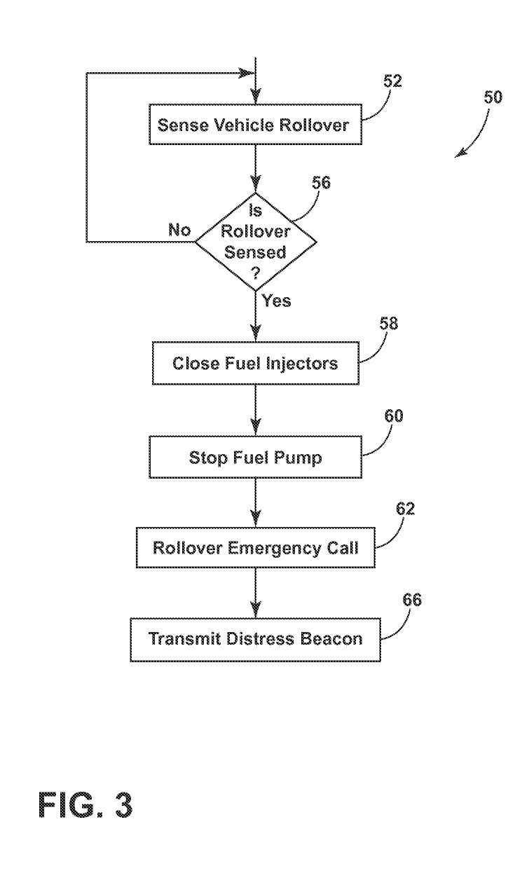

As shown in the flow chart 50 of FIG. 3, in operation a first step 52 is the inertial sensor unit 22 sensing rollover of a vehicle for providing an inertial sensor unit signal of a rollover condition to the processor 14 of the ECU 12 via the CAN bus 18 or a direct connection. The processor 14 then executes a program to advance to step 54.

At step 56, the processor 14 of the ECU 12 determines if a rollover was sensed by the inertial sensor unit 22. If NO, the processor returns to first step 52, if YES, the processor advances the program to step 58.

At step 58, the processor 14 of the ECU 12 provides a fuel cut-off signal via the CAN bus 18 to the fuel injection control 32. In response to the fuel cut-off signal, the fuel injection control 32 closes the fuel injectors to block fuel from a vehicle engine. Closing fuel injectors provides an almost immediate cut-off in the supply of fuel to the engine. The processor 14 advances to step 60.

At step 60, the processor 14 provides a fuel pump stop signal to the fuel pump control 34. In response to the fuel pump stop signal, the fuel pump control 34 stops providing power to the vehicle fuel pump. In one embodiment, the fuel pump control 34 prevents the flow of electricity to the motor of the fuel pump for the vehicle engine. By stopping the operation of the fuel pump, and thus the vehicle engine when the oil pan is not disposed below the engine due to rollover, damage to the engine is avoided. Thus, protecting the engine from operating without sufficient engine oil is achieved. Then, the processor 14 advances to step 62.

### Rollover Location

At step 62, the processor 14 of the ECU 12 sends a call signal to the rollover emergency caller 38. The rollover emergency caller 38 automatically operates to call via a preprogrammed or selected telephone number over a cellular radio frequency, or to call on another communication frequency, such as a police channel, to actively indicate and inform of a vehicle rollover event and to automatically request assistance from police, fire, ambulance or others. Other cellular communication arrangements are contemplated. Performing the call automatically provides help when a user is unable to do so. In some embodiments, the processor 14 of the ECU 12 provides an emergency number for the rollover emergency caller 38 to provide a rollover emergency call that includes a predetermined message identifying the vehicle and the location thereof as determined by the GPS 40. Thereafter, the processor 14 advances to step 66.

At step 66, the processor 14 provides signals via the CAN bus 18 to a location signal transmitter 42. The location signal transmitter 42 transmits a distress beacon or signal continuously or intermittently. The distress signal allows a searcher to find the vehicle without using GPS location coordinates or in instances where the position of the vehicle changes after the emergency call or otherwise.

The above method protects a vehicle from engine damage after rollover and the locating arrangement assists a searcher in finding an off-road vehicle after rollover. Thus, a remote S×S, ROV, UTV, ATV or other off-road vehicle protects a vehicle engine and provides locating and vehicle identification signals, including transmission of a signal for location purposes.

The vehicle control system 10 is mainly contemplated for off road vehicles, including three wheeled and four wheeled vehicles, such as vehicles from a group consisting of an all-terrain vehicle, a utility terrain vehicle, a dune buggy and a rally car. The vehicle control system 10 is also contemplated for jeeps, military vehicles, and racing vehicles, such as a dune buggy. General vehicles that include trucks and cars are also contemplated for the rollover engine protection arrangement.

### Performance Hand Brake

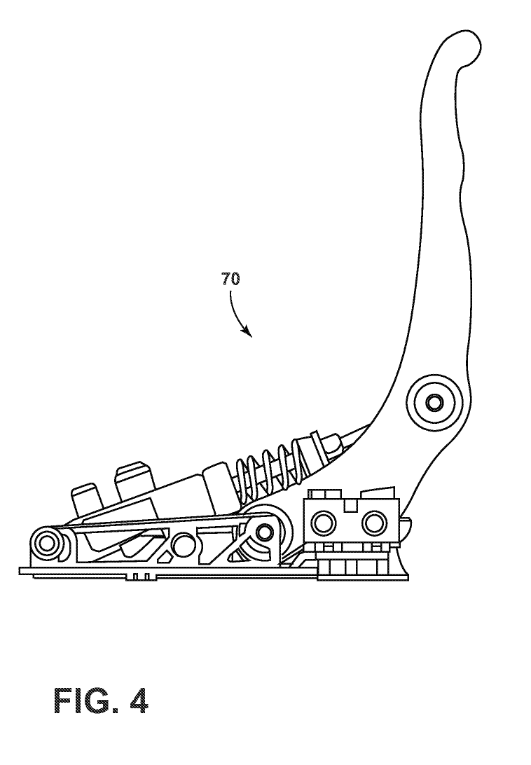

FIG. 4 shows a cross section of a performance hand brake 70 that includes a hand brake sensor 30. The performance hand brake 70 emulates traditional hand brake functionality via pressure builds using a pump in a rear wheel brake unit 31. The arrangement preserves traditional hand brake functionality for a rally car or the like. Thus, his arrangement expands the adoption of electronic hand brake systems into high-performance vehicles which traditionally have been opposed to the adoption of an electronic hand brake system. Additionally, this software-based function is far more advanced than a traditional mechanically-actuated hand brake in the actual application of braking force to a vehicle's wheels.

The performance hand brake function emulates the operation of a mechanical hand brake during non-stationary vehicle operation by using pump of a hydraulic unit of the rear wheel brake unit 31 to build pressure in the wheel circuits of the rear wheels for braking. The actuation of the function is provided via an external request from the brake sensor 30, or an internal request from software function integration. The performance hand brake 70 typically does not include or is free from a brake locking mechanism. Thus, upon release, the brakes are no longer actuated. Traditionally, a mechanical hand brake only acts on the rear wheels of a rally car type of vehicle, which is the primary functionality emulated by this arrangement. Additional pressure builds can be performed on the front wheels of the vehicle if required to modify the yaw rate or trajectory of the vehicle and to provide further integration with the ESP ECU 12.

### System Inputs

The request for hand brake operation is through a simple switch (on/off) in simple systems. In one embodiment, the hand brake sensor 30 is a pedal or lever travel sensor integrated to provide more fidelity in the requested braking strength in more advanced systems. The hand brake sensor 30 is mounted to a traditional hand brake lever or other actuation device at a driver location or in a cockpit with a method of simulating an increase of braking force with travel (typically, springs and rubber bump stops to limit travel) as shown in cross-section in FIG. 4. Additional sensor options include force, pressure in a hydraulic circuit, an angular position sensor, a linear potentiometer, etc. The sensor signal is transmitted to the ESP ECU 12 via dedicated wiring, the CAN bus 18 using CAN communication protocol, or using any other communication protocol used by a vehicle manufacturer.

### System Functionality

The ESP ECU 12 receives the request for hand brake actuation from the hand brake sensor 30. In the case of a switch-based system, the ECU 12 commands a simultaneous pressure build to occur on both rear wheel circuits through the rear wheel brake unit 31. This build is calibrated and is based on one or more of a number of system variables (vehicle speed, vehicle acceleration, vehicle yaw rate, time, maximum pressure allowed, ESP vehicle models and intervention). In the case of a variable signal from a hand brake sensor 30 or other sensor, the pressure build typically is proportional to an input signal from the hand brake sensor 30 in order to provide greater fidelity to the braking force applied to the rear axle. This proportionality typically is further modified by the same system variables as a switch-based system.

Integration with Electronic Stability Program software

The pressure build request is coordinated in the same manner as other pressure build requests in software executed by the processor 14 of the ESP ECU 12. As the electronic stability program (ESP) is designed to prevent vehicle sliding and this braking function inherently causes vehicle sliding, the ESP commands for brake torque, engine torque, and other active chassis controls are at least one of a) overridden when the performance hand brake request is active, b) use the request to allow later or softer interventions (thereby allowing for controlled trajectory change with rotation), c) act as an additional ESP control modification based on driver desired vehicle rotation, and/or d) ignored in some specific situations. The performance hand brake functionality is linked to the electronic stability program operating modes in order to prevent functionality in a key-up mode but to allow functionality in a “sport” or “race” context or mode. The performance hand brake 70 in operation, in some embodiments, requests motor torque increases or decreases if necessary, sends requests to couple or decouple drivetrain components if permitted by vehicle architecture, or actuates other active control systems (aerodynamics, suspension, steering mechanisms).

### Driver Configurable ESP

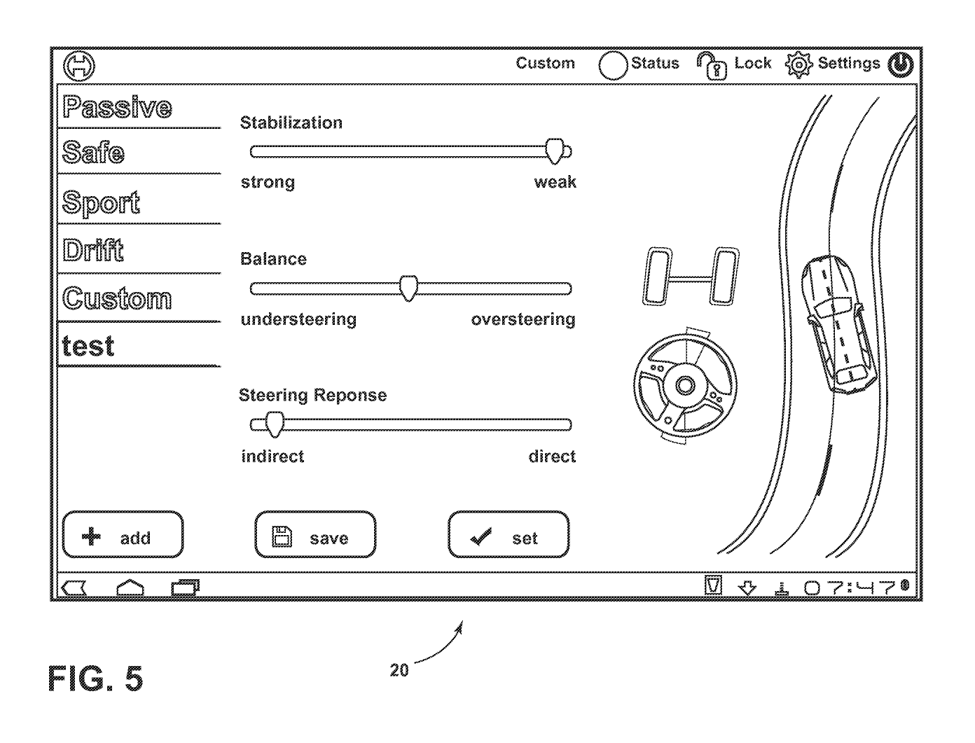

Manual calibration allows the ESP ECU 12 to be programmed by a driver to adjust yaw control for faster/safer driving conditions for a vehicle. The user interface 20 shown in FIG. 5 is a touch screen for a user to make adjustments/selections of ESP performance in field. The adjustments allow real-time or on-the-fly changes to be manually made by a user, for example, of a rally car or an off-road vehicle. Programming of vehicle handling can be changed and customized. Stabilization control, balance and steering response for a vehicle can be changed. Selections shown in FIG. 5 are Passive, Safe, Sport and Drift modes, wherein preset properties are provided. Touching the user interface 20 enables selecting of a desired mode.

### Example of System Functionality 1: Front Wheel Drive Car

A driver or user is on a closed course with “Sport” mode engaged. A driver brakes for a hairpin turn and uses the hand brake 70 to command rear brake pressure. The ESP ECU 12 commands a proportional brake pressure build on the rear wheels. Vehicle rotation begins and ESP interventions are suppressed. The driver releases the hand brake 70 when desired vehicle trajectory has been reached; and soft ESP intervention is allowed if needed to arrest vehicle yaw. The driver accelerates from a turn.

### Example of System Functionality 2: Front Wheel Drive Car (Additional Functionality)

The driver is on a closed course with “Sport” mode engaged. A driver brakes for a hairpin turn and uses the hand brake 70 to command rear brake pressure. The ESP ECU 12 commands a proportional brake pressure build on rear wheels. Vehicle rotation begins and ESP interventions are suppressed. In one instance, the driver hand brake initiation was not well timed and vehicle yaw rate is below target yaw rate for this vehicle speed /steering/yaw condition. Performance hand brake logic requests motor torque increase and also pressure build on inside front wheel to increase yaw rate of the vehicle. The vehicle reaches desired trajectory, the driver releases the hand brake 70, ESP soft activation occurs to arrest vehicle yaw if necessary, and the driver accelerates away from the corner.

### Example of System Functionality 3: All Wheel Drive Car

A driver is on a closed course with “Sport” mode engaged. A driver brakes for a hairpin turn and uses the hand brake 70 to command rear brake pressure. The ESP ECU 12 commands a proportional brake pressure build on the rear wheels and sends a request to uncouple the center differential, if necessary. Vehicle rotation begins and ESP interventions are suppressed. The driver releases the hand brake 70 when a desired vehicle trajectory has been reached; and soft ESP intervention is allowed, if needed, to arrest vehicle yaw. The center differential recouples and the driver accelerates from the turn.

### Example of System Functionality 4: All Wheel Drive Car (Additional Functionality)

A driver is on a closed course with “Sport” mode engaged. A driver brakes for a hairpin turn and uses the hand brake 70 to command rear brake pressure. The ESP ECU 12 commands a proportional brake pressure build on the rear wheels and sends a request to uncouple the center differential. Vehicle rotation begins and ESP interventions are suppressed. The driver hand brake initiation was not well timed and the vehicle yaw rate is below a target yaw rate for the vehicle speed/steering/yaw condition. Performance hand brake logic requests a motor torque increase and recouples center differential. Pressure builds occur as needed to cause oversteer, yaw moment and to properly distribute motor torque on current surface mue. The vehicle reaches desired trajectory, the driver releases the hand brake 70, ESP soft activation occurs to arrest vehicle yaw if necessary, and the driver accelerates away from the corner.

### Example of System Functionality 5: Rear Wheel Drive Vehicle

The driver is on a closed course with “Sport” mode engaged. A driver brakes for a hairpin turn, and uses the hand brake 70 to command rear brake pressure. The ESP ECU 12 commands a proportional brake pressure build on the rear wheels. Vehicle rotation begins and ESP interventions are suppressed. The driver releases the hand brake 70 when desired vehicle yaw rate and body side slip angle (Beta) have been reached and resumes positive motor torque request. ESP enters a new “Beta Hold Mode” and uses the current yaw rate and the body side slip angle as targets and increases or decreases vehicle beta based on driver steering request. The driver begins to countersteer and the beta target beta reduces proportional to the amount of countersteer, and control ends when the driver has obtained a desired vehicle trajectory. Then the driver accelerates from or out of the turn.

In some embodiments, the ESP ECU 12 includes software and the processor 14 or controller executes various algorithms or programs. In some embodiments, an application-specific integrated circuit (ASIC) is utilized as the processor 14. In another embodiment, a separate unit based off hydraulic brake boost (HBB) acts to build pressure on rear wheels (and potentially inside front wheels) based off a position of the hand brake 70. Output of the rear wheel brake unit 31, in some embodiments, is integrated into a vehicle dynamic control (VDC) to modify control based off a driver's direct request for oversteer. In some embodiments, the vehicle control system 10 is calibrated by a test system to obtain proper hand brake feel and system performance.

In one embodiment, a hand brake system for providing different braking in different selected operating modes comprises: an input interface for selecting an operating mode for the braking system; a hand brake for assisting in controlling the braking system; and an electronic control unit for receiving the selected operating mode from the input interface, and for communicating with the hand brake by receiving signals from the hand brake and for controlling force applied to adjust the hand brake, wherein the electronic control unit includes a processor and a computer memory configured to: determine an operating mode for the electronic control unit; provide signals to generate a “proportional build” bias force for the hand brake; receive a brake signal corresponding to a response to force applied to the hand brake; and control at least the braking system in response to force applied to the hand brake.

In another embodiment of the hand brake system, controlling the hand brake system comprises controlling braking of two rear wheels for over-steering the vehicle. In one embodiment, a vehicle operator selects one of a sport mode and a race mode.

In another embodiment, a vehicle operator selects one of a keyboard mode, a sport mode, and a race mode, wherein the hand brake applies force to the rear wheels of a vehicle to provide oversteer, and wherein the amount of oversteer for a given force applied to the hand brake differs depending on the selected mode.

In one embodiment of the hand brake system, a vehicle yaw rate sensor senses vehicle yaw rate and provides the vehicle yaw rate to the electronic control unit.

In one embodiment, the electronic control unit comprises an electronic stability program electronic control unit, wherein the computer memory stores an electronic stability program for execution by the processor.

In one embodiment, the hand brake acts as an electronic parking brake in a safe mode.

In another embodiment, the operating modes comprise a passive mode, a safe mode, a sport mode, and a drift mode for the handbrake system, and the input interface for selecting an operating mode for the braking system includes a touchscreen.

In one embodiment of the hand brake system, the electronic control unit is configured to receive inputs manually input at the touchscreen to: adjust stabilization; adjust balance corresponding to understeering and oversteering; and adjust steering response corresponding to indirect and direct steering response.

In another embodiment of the hand brake system, the electronic control unit is configured to receive inputs manually input at the touchscreen to provide a custom hand brake operation by enabling a user to: adjust stabilization, adjust balance corresponding to understeering and oversteering, and adjust steering response corresponding to indirect and direct steering response.

In another embodiment, the hand brake system includes an inertial sensor unit for sensing inertia and providing the inertia to the electronic control unit.

Thus, the invention provides, among other things, systems and a method for protecting a vehicle engine from rollover of a vehicle. Other constructions of this invention can utilize different arrangements. Further, an electronic hand brake is disclosed that can utilize different arrangements. Various features and advantages of the invention are set forth in the following claims.

What is claimed is:

1. A vehicle rollover engine protection system for a vehicle including an engine, comprising:
an inertial sensor unit for sensing rollover of the vehicle;
a fuel injection control;
a fuel pump control;
an electronic control unit including a processor and a memory; and
a communication bus for providing communication from the inertial sensor unit to the electronic control unit, and for providing communication between the electronic control unit and each of the fuel injection control and the fuel pump control,
wherein, when the electronic control unit receives an inertial sensor unit signal indicating that a vehicle rollover has occurred, the processor of the electronic control unit is configured to:
close fuel injectors to cut-off fuel to the engine of the vehicle with the fuel injection control, and
stop operation of a fuel pump of the engine with the fuel pump control.

2. The vehicle rollover engine protection system according to claim 1, wherein the vehicle is from a group consisting of all-terrain vehicles, recreational off highway vehicles, side-by-side vehicles, utility terrain vehicles, dune buggies and rally cars.

3. The vehicle rollover engine protection system according to claim 1, wherein the inertial sensor unit senses force about at least a z-axis.

4. The vehicle rollover engine protection system according to claim 1, further comprising:
a global positioning system;
a location signal transmitter; and
a rollover emergency caller,
the communication bus for providing communication from the global positioning system to the electronic control unit, and for providing communication between the electronic control unit and each of the rollover emergency caller and the location signal transmitter,
wherein, when the electronic control unit receives the inertial sensor unit signal indicating that the vehicle rollover has occurred, the processor of the electronic control unit is configured to:
determine a location of the vehicle from signals from the global positioning system,
perform a rollover emergency call to actively indicate rollover of the vehicle and provide vehicle identification and location, and
transmit a location signal from the vehicle.

5. The vehicle rollover engine protection system according to claim 4, wherein the vehicle is from a group consisting of all-terrain vehicles, recreational off highway vehicles, side-by-side vehicles, utility terrain vehicles, dune buggies and rally cars.

6. The vehicle rollover engine protection system according to claim 4, wherein the inertial sensor unit senses force at least about a z-axis.

7. A method of protecting an engine in a vehicle rollover event for an off-road vehicle, comprising:
sensing rollover of the off-road vehicle and providing an inertial sensor unit signal;
closing fuel injectors to cut-off fuel to the engine of the off-road with a fuel injection control in response to the sensing rollover of the off-road vehicle; and
stopping operation of a fuel pump for the engine of the off-road vehicle in response to the sensing rollover of the off-road vehicle.

8. The method of protecting the engine of an off-road vehicle according to claim 7, and when the inertial sensor unit signal is provided, further comprising identifying and locating the off-road vehicle by
determining a location of the off-road vehicle from signals from a global positioning system,
performing a rollover emergency call to actively indicate rollover of the off-road vehicle and provide vehicle identification and location, and
transmitting a location signal or a beacon from the off-road vehicle.

9. The method according to claim 8, wherein rollover is sensed by the inertial sensor unit at least about a z-axis.

10. The method according to claim 8, wherein the off-road vehicle is from a group consisting of an all-terrain vehicles, recreational off highway vehicles, side-by-side vehicles, utility terrain vehicles, dune buggies and rally cars.

11. The method according to claim 7, wherein the off-road vehicle is from a group consisting of all-terrain vehicles, recreational off highway vehicles, side-by-side vehicles, utility terrain vehicles, dune buggies and a rally car.

12. The method according to claim 7, wherein rollover is sensed by the inertial sensor unit at least about a z-axis.

13. A vehicle rollover engine protection and location system for a vehicle including an engine, comprising:
an inertial sensor unit for sensing rollover of the vehicle;
a fuel injection control;
a fuel pump control;
a global positioning system;
a rollover emergency caller;
a location signal transmitter;
an electronic control unit including a processor and a memory; and
a communication bus for providing communication from the inertial sensor unit and the global positioning system to the electronic control unit, and for providing communication between the electronic control unit and each of the fuel injection control, the fuel pump control, the location signal transmitter and the rollover emergency caller,
wherein, when the electronic control unit receives an inertial sensor unit signal indicating that a vehicle rollover has occurred, the processor of the electronic control unit is configured to:
close fuel injectors to cut-off fuel to the engine of the vehicle,
stop operation of a fuel pump of the engine with the fuel pump control,
determine a location of the vehicle from signals from the global positioning system,
perform a rollover emergency call to actively indicate rollover of the vehicle and to provide vehicle identification and location, and
transmit a location signal.

14. The vehicle rollover engine protection and location system according to claim 13, wherein the location signal includes a distress beacon.

15. The vehicle rollover engine protection and location system according to claim 13, wherein the vehicle is from a group consisting of all-terrain vehicles, recreational off highway vehicles, side-by-side vehicles, utility terrain vehicles, dune buggies and rally cars.

16. The vehicle rollover engine protection and location system according to claim 13, wherein the rollover emergency caller includes a cellular communication arrangement.

17. The vehicle rollover engine protection and location system according to claim 13, wherein the inertial sensor unit sensors force at least about a z-axis.

18. The vehicle rollover engine protection and location system according to claim 13, wherein the system is an off-road vehicle rollover engine protection and location system, and wherein the vehicle is an off-road vehicle.
